(19) United States
(12) Patent Application Publication
(10) Pub. No.: US 2024/0265303 A1
(43) Pub. Date: Aug. 8, 2024

(54) MULTI-TASK LEARNING METHOD AND RELATED DEVICE

(71) Applicant: Beijing University of Posts and Telecommunications, Beijing (CN)

(72) Inventors: Dandan LI, Beijing (CN); Xiaohong HUANG, Beijing (CN); Kun XIE, Beijing (CN); Pei ZHANG, Beijing (CN); Yuqi ZHAO, Beijing (CN)

(73) Assignee: Beijing University of Posts and Telecommunications, Beijing (CN)

(21) Appl. No.: 18/325,041

(22) Filed: May 29, 2023

(30) Foreign Application Priority Data
Feb. 2, 2023 (CN) 202310110092.8

(51) Int. Cl. G06N 20/00

(52) U.S. Cl. CPC G06N 20/00

(57) ABSTRACT

A multi-task learning method comprises: determining participating nodes; performing clustering to the participating nodes and determining several clusters; determining a global model for the clusters according to the several clusters and by means of the federated learning within the cluster; determining a cluster key feature set of any one of the clusters according to the cluster model and by means of calculation with the SHAP framework; determining a global model according to the cluster key feature set; and training the global model according to the any one of the clusters, and determining the cluster model of the any one of the clusters, wherein a plurality of the clusters are used for achieving multi-task learning. In the present application, by clustering, the participating nodes having similar device performance and data distribution are collected into the same group, and the participating nodes within the same cluster are trained together.

### CROSS-REFERENCE TO RELATED APPLICATIONS

This application claims priority to Chinese patent application Ser. No. 202310110092.8, filed on Feb. 2, 2023, the content of which is incorporated herein by reference in its entirety.

### TECHNICAL FIELD

The present application relates to a technical field of data processing, and specifically to a multi-task learning method based on federated learning and a related device.

### BACKGROUND

In a transmission network with node heterogeneity, the prior problem of heterogeneity causes problems of decreased model precision and overlong training time consumption for the conventional federated learning. Moreover, the solution to the prior problem of heterogeneity is less adaptive in the solution manner. It can solve only a single problem of the decreased precision or of the overlong training time consumption, but can not solve both the problems of the decreased model precision and the overlong training time consumption, thus its application situation is limited.

### SUMMARY

Therefore, the objective of the present application is to provide a method, an apparatus, an electronic device and a storage medium for multi-task learning based on federated learning.

Based on the above objective, in the present application, a multi-task learning method based on federated learning is provided, comprising: determining participating nodes; performing clustering to the participating nodes and determining several clusters; determining a cluster model according to the several clusters and by means of calculation with the federated learning; determining a cluster key feature set of any one of the clusters according to the cluster model and by means of calculation with the SHAP framework; determining a global model according to the cluster key feature set; and training the global model according to the any one of the clusters, and determining the cluster model of the any one of the clusters, wherein a plurality of the clusters are used for achieving multi-task learning.

Optionally, the step of performing clustering to the participating nodes, before determining the several clusters, comprises: determining a node training model, and training the participating nodes by the node training model; determining a training time and a model weight in response to determining that a preset number of times of training is reached; and performing clustering to the participating nodes according to the training time and the model weight, and determining several clusters.

Optionally, the method comprises: performing clustering to the participating nodes by the K-Means algorithm.

Optionally, the step of determining a cluster model according to the several clusters and by means of calculation with the federated learning comprises: determining a cluster center according to the clusters; training the clusters by the federated learning; and determining the calculation model as the cluster model in response to determining that a number of times of training reaches a preset threshold.

Optionally, the step of determining a cluster key feature set of any one of the clusters according to the cluster model and by means of calculation with the SHAP framework comprises: analyzing the cluster model by the SHAP framework, and determining a data feature and a data feature value of any one of the participating nodes in the clusters; determining a node key feature set according to the data feature value; and obtaining a union set for a plurality of the node key feature sets, and determining the cluster key feature set.

Optionally, the step of determining a node key feature set according to the data feature value comprises: determining the data feature corresponding to the data feature value as a key feature in response to determining that the data feature value is higher than a preset threshold; and determining the node key feature set according to the key feature.

Optionally, the step of determining a global model according to the cluster key feature set comprises: obtaining an intersection set for a plurality of the cluster key feature sets, and determining a global key feature set; and performing feature masking for data of the participating nodes according to the global key feature set, and determining the global model.

Based on the same inventive concept, in an embodiment of the present application, a device for multi-task learning based on federated learning is further provided, comprising:
a first determining module, configured for determining participating nodes;
a clustering module, configured for performing clustering to the participating nodes and determining several clusters;
a first calculating module, configured for determining a cluster model according to the several clusters and by means of calculation with the federated learning;
a second calculating module, configured for determining a cluster key feature set of any one of the clusters according to the cluster model and by means of calculation with the SHAP framework;
a second determining module, configured for determining a global model according to the cluster key feature set; and
a training module, configured for training the global model according to the any one of the clusters, and determining the cluster model of the any one of the clusters, wherein a plurality of the clusters are used for achieving multi-task learning.

Based on the same inventive concept, in an embodiment of the present application, an electronic device is further provided, comprising a memory, a processor, and a computer program which is stored on the memory and can run on the processor, characterized in that the multi-task learning method based on federated learning according to any embodiment as above is implemented when the processor is executing the program.

Based on the same inventive concept, in an embodiment of the present application, a non-transitory computer-readable storage medium storing a computer instruction is further provided, characterized in that the computer instruction is used to make a computer execute the multi-task learning method based on federated learning according to any embodiment as above.

As can be seen from above, a method, an apparatus, an electronic device and a storage medium for multi-task learning based on federated learning are provided in the present application. Herein, the multi-task learning method based on federated learning comprises: determining participating nodes; performing clustering to the participating nodes and determining several clusters; determining a cluster model according to the several clusters and by means of calculation with the federated learning; determining a cluster key feature set of any one of the clusters according to the cluster model and by means of calculation with the SHAP framework; determining a global model according to the cluster key feature set; and training the global model according to the any one of the clusters, and determining the cluster model of the any one of the clusters, wherein a plurality of the clusters are used for achieving multi-task learning. In the present application, by a manner of clustering, the participating nodes having similar device performance and data distribution are collected into the same group, and the participating nodes within the same cluster are trained together, avoiding the influence by the participating nodes having different device type or data distribution, and enabling alleviating the problem(s) due to device heterogeneity. By a manner of feature masking, only the related parameters of the feature(s) regarded as key/essential by all the nodes are trained, alleviating the problem(s) due to data heterogeneity.

### BRIEF DESCRIPTION OF THE DRAWINGS

In order to explain the technical solutions in the present application or in the related art more clearly, the figures necessary to be used for description in the embodiments or in the related art will be briefly introduced as below. Apparently, the figures for the description below are only for some embodiments of the present application. Based on these figures, those skilled in the art can obtain other figures without any inventive work.

FIG. 1 is a flow diagram of a multi-task learning method based on federated learning in an embodiment of the present application.

FIG. 2 is an implementation demonstration diagram of a multi-task learning method based on federated learning in an embodiment of the present application.

FIG. 3 is a structural diagram of a device for multi-task learning based on federated learning in an embodiment of the present application.

FIG. 4 is a structural diagram of an electronic device in an embodiment of the present application.

### DETAILED DESCRIPTION OF THE EMBODIMENTS

Hereinafter, in order to make the objective(s), technical solution(s) and advantages of the present application clearer and more understandable, the present application will be further described in detail, in connection with specific embodiments and with reference to the accompanying drawings.

It is necessary to be noted that the technical terms or scientific terms used in the embodiments of the present application should have common meanings as understood by those skilled in the art of the present application, unless otherwise defined. The “first”, “second” and similar words used in the embodiments of the present application do not refer to any sequence, number or importance, but are only used to distinguish different component portions. The “comprise”, “include” or a similar word means that an element or item before such word covers an element or item or any equivalent thereof as listed after such word, without excluding other elements or items. The “connect” or “interconnect” or a similar word does not mean being limited to a physical or mechanical connection, but may include a direct or indirect electrical connection. The “upper”, “lower”, “left” and “right” are used only to indicate a relative position relation, and after the absolute position of the described object is changed, the relative position relation may be changed accordingly.

As described in the section of background, in a transmission network with node heterogeneity, the prior problem of heterogeneity causes problems of decreased model precision and overlong training time consumption for the conventional federated learning. Moreover, the solution to the prior problem of heterogeneity is less adaptive in the solution manner. It can solve only a single problem of the decreased precision or of the overlong training time consumption, but can not solve both the problems of the decreased model precision and the overlong training time consumption, thus its application situation is limited.

Specifically, in a transmission network with node heterogeneity, with the federated learning, there are two challenges now for the federated learning. Firstly, the problem of data heterogeneity causes a problem of model precision. That is, the data from different devices are not independently and identically distributed (IID). For example, people from different districts have different facial features and verbal accents. From the perspective of data protection, data sharing between devices can not be achieved for the federated learning, thus increasing the difficulty for detection of data heterogeneity. Secondly, the problem of device heterogeneity causes a problem of overlong time consumption for training. The tasks of mobile or peripheral calculation devices are performed only when the devices are idle, are charged, or are connected to an uncharged network. Moreover, the connection between the device and a remote server may often be unavailable or slow. Many researchers use a manner of federated multi-task learning to study a potential relation between the tasks, to alleviate data heterogeneity. In addition, many researchers also use a manner of asynchronous updating to alleviate the problem of overlong waiting time due to device difference(s). However, currently, there is no solution well developed to solve both the problems as above, and the scene requirement and calculation requirement on the user side can not be met.

Therefore, in the embodiments of the present application, a method, an apparatus, an electronic device and a storage medium for multi-task learning based on federated learning are provided, to solve the problems in the prior art: decreased model precision and overlong training time consumption for the conventional federated learning due to the problem of heterogeneity.

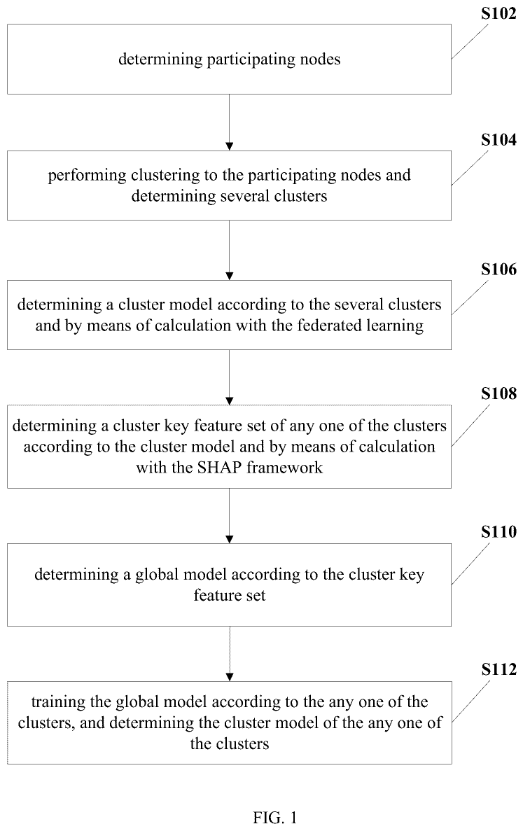

As shown in FIG. 1, the multi-task learning method based on federated learning, as provided in an embodiment of the present application, comprises:
Step S102: determining participating nodes;
Step S104: performing clustering to the participating nodes and determining several clusters;
Step S106: determining a cluster model according to the several clusters and by means of calculation with the federated learning;
Step S108: determining a cluster key feature set of any one of the clusters according to the cluster model and by means of calculation with a SHapley Additive exPlanations (SHAP) framework;
Step S110: determining a global model according to the cluster key feature set;
Step S112: training the global model according to the any one of the clusters, and determining the cluster model of the any one of the clusters, wherein a plurality of the clusters are used for achieving multi-task learning.

In the present application, a central server and several participating nodes are included. In Step S102, the central server first determines the number of the participating nodes and the type(s) of the participating nodes, determines a node data calculation model for the participating nodes according to the number of the participating nodes and the type(s) of the participating nodes, and sends the parameter(s) of the node data calculation model to the participating node(s).

Further, in Step S102, the participating node may be understood as terminal devices having a calculation function or a data processing function. The data processed by the devices are of various types. The data may be image data or may be formatted data, for analysis, or for predicting a health event (such as hypoglycemia or risky heart disease) due to a wearable device, or monitoring/detecting an act of theft in a smart home. Therefore, the participating nodes are also of various types. With different application scenes for the terminal devices, the types of the participating nodes are different.

In Step S104, the participating nodes are clustered. Before determining several clusters, it is first to determine a node training model of the participating nodes. The training is performed by the node training model according to the local data of the participating nodes, and a training time and a model weight are determined by the training. Further, according to the training time and the model weight, the participating nodes are clustered by the K-Means algorithm, and the several clusters are determined. Further, both the data volume of the terminal devices during the training and the data processing ability of the terminal devices will influence the training time.

In some optional implementations, the training time is corresponding to the device performance. That is, the shorter is the training time, the better is the device performance and thus is the training ability of the device. The model weight is corresponding to the data distribution. That is, the higher is the similarity in the model weight, the higher is the similarity in the data distribution. The higher is the similarity in training time and weight value of any two or three or more participating nodes, the higher is the similarity of the participating nodes. Thus, the similar participating nodes are clustered to determine the several clusters.

It should be explained that in the training by the node training model, first a threshold of the number of times of training is set, and when the number of times of training is larger than the preset threshold, the training will be stopped. The training time and the model weight in the last training are recorded. Herein, the preset number of times of training may be set according to the actual condition. For example, it may be set as 50, and the training will be stopped when the number of times of training is larger than 50, such as 51. The current training time and the model weight in the last training are recorded. Certainly, during practical use, according to the difference in data volume and/or data processing ability of the device, the threshold of the number of times of training may not be set as 50 and may be adjusted according to the actual condition, which will not be defined in the present application.

In some optional implementations, for selection of the model weight, it is not necessary to select the model weight in the last training as the clustering basis. It is also possible to select the maximum or minimum model weight as the clustering basis. Certainly, it is also possible to select an average value of the weights in multiple training processes.

In some optional implementations, the K-means algorithm is used for clustering. Further, clustering is a kind of unsupervised learning. For the clustering, a “label” is set in advance. A relation between data objects is found in the data, and the data are grouped, wherein one group is called as “one cluster”. The higher is the similarity within a group and the higher is the distinctiveness between groups, the better is the clustering effect. That is, when the similarity of objects within a cluster is relatively high and the similarity of objects between clusters is relatively low, the clustering effect will be better.

In some optional implementations, after the training time and the model weight are determined, the participating node uploads the training time and the model weight to the central server. The central server receives the training time and the model weight uploaded from each of the participating nodes, and performs clustering to several participating nodes according to the training time(s) and the model weight(s), to classify them into a plurality of clusters. In this case, heterogeneous nodes are classified into different clusters. The cluster model and the training time consumption are different for the different clusters, while the training time and the model weight are similar for the participating nodes within a cluster. The training time and the model weight correspond to the device performance and the data distribution, respectively, and thus the participating nodes within the same cluster can be considered as being similar in data distribution and device performance.

In some optional implementations, after the clusters are determined, any one participating node is selected from the clusters as a cluster center. In the various clusters, the federated learning is performed for iteration training. After the number of times of iteration reaches a preset number of times of iteration, a cluster model is determined, recorded as wk, wherein w is the global model and k is the serial number of the cluster, k=1,2,3, . . . ,n. It should be explained that after the participating nodes are clustered, it is possible to determine a plurality of clusters and to sequence the clusters. Herein, before the iteration training, a threshold of number of times of iteration is first set. When the number of times of iteration reaches the preset threshold, the cluster model wk will be output.

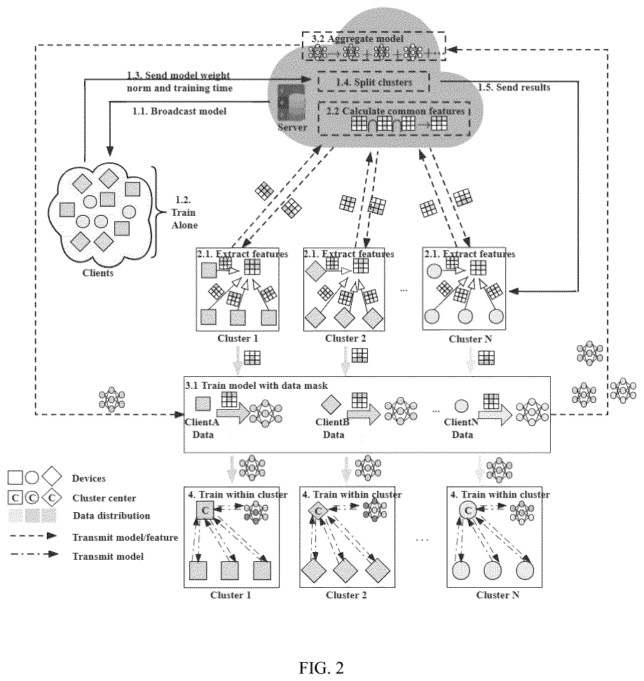

In some optional implementations, the participating node determines the feature value thereof according to the cluster model determined by iteration. Specifically, it comprises: analyzing the cluster model by the SHAP framework, determining the data feature of the participating node, performing calculation according to the data feature and the cluster model, determining the feature value of the participating node, and further, comparing the feature value of the participating node with a preset threshold, and determining the data feature of the participating node corresponding to the feature value as the key feature when it is determined that the feature value is larger than the threshold. Also, the data features of the participating nodes in each cluster whose feature values are larger than the preset threshold are collected into one set, thus obtaining a plurality of node key feature sets. Herein, the threshold may be configured according to the actual calculation condition. For different calculation volumes or calculation manners, the threshold may be different, which will not be specifically defined herein in the present application. Further, a union set is obtained for a plurality of the node key feature sets, and further the cluster key feature set is determined according to the node key feature sets. As shown in FIG. 2, it is a demonstration diagram of an application process of a multi-task learning method based on federated learning in the present application. As can be seen from FIG. 2, in the initial period, the participating nodes are in the disordered state and the arrangement thereof is very random. In the present application, by the K-means algorithm, the participating nodes are clustered, determining several clusters, i.e., the cluster 1, the cluster 2 and the cluster 3 as shown in FIG. 2. Herein, in some other implementations, there may be innumerable clusters, rather than just 3. The number of the clusters is related to the type(s) of the nodes, and is determined according to the type(s) of the nodes. It is understandable that when there are 3 types of the nodes, all the nodes may be classified into 3 clusters, and when there are 10 or 20 types of the nodes, all the nodes may be classified into 10 or 20 clusters. When there are more types of the nodes, there may be more clusters.

Furthermore, after the cluster key feature is determined, it is possible to perform calculation according to the cluster key feature. The central server performs intersection set operation for the key features of all the clusters, obtaining the global key feature(s).

In some optional implementations, after the global key feature set is determined, the technology of feature masking is used according to the global key feature set. According to the global key feature set, any feature(s) other than the features in the global key feature set in each participating node will be masked, and the training is performed by means of data other than those being masked, thus preventing the participating nodes from being influenced by the feature(s) unrelated thereto, and alleviating any problem due to data heterogeneity. In the last clustering training period, the participating nodes within each cluster are trained individually/independently, without waiting for the participating nodes within other cluster(s) having a slow calculation speed, thus reducing the waiting time of the participating nodes.

In some optional implementations, the step of training the global model according to the any one of the clusters and determining the cluster model of the any one of the clusters specifically comprises: training the global model for the nodes in the clusters based on the respective local data, and performing model aggregation within each cluster until the global model is converged, thus determining the cluster model. After the cluster model is determined, different data in different application scenes are processed for each cluster according to the corresponding cluster model. When different data are received, the cluster models in different clusters may train or process the different data simultaneously. As can be seen from above, the participating nodes within each cluster are trained individually/independently, without waiting for the participating nodes within other cluster(s) having a slow calculation speed, thus reducing the waiting time of the participating nodes, and alleviating the problem(s) due to device heterogeneity.

As can be seen from above, a method, an apparatus, an electronic device and a storage medium for multi-task learning based on federated learning are provided in the present application. Herein, the multi-task learning method based on federated learning comprises: determining participating nodes; performing clustering to the participating nodes and determining several clusters; determining a cluster model according to the several clusters and by means of calculation with the federated learning; determining a cluster key feature set of any one of the clusters according to the cluster model and by means of calculation with the SHAP framework; determining a global model according to the cluster key feature set; and training the global model according to the any one of the clusters, and determining the cluster model of the any one of the clusters, wherein a plurality of the clusters are used for achieving multi-task learning. In the present application, by a manner of clustering, the participating nodes having similar device performance and data distribution are collected into the same group, and the participating nodes within the same cluster are trained together, avoiding the influence by the participating nodes having different device type or data distribution, and alleviating the problem(s) due to data heterogeneity and device heterogeneity. Further, by a manner of feature masking, only the related parameters of the feature(s) regarded as key/essential by all the nodes are trained, alleviating the problem(s) due to data heterogeneity.

It should be explained that the methods in the embodiments of the present application may be performed by a single device, such as a computer or a server. Also, the methods in the embodiments of the present application may be applied to a distributed scene, and be implemented by cooperation of a plurality of devices. In the case of such distributed scene, one of the plurality of devices may perform only one or more steps in the methods in the embodiments of the present application, and the plurality of devices can interact with one another to implement the method(s).

It should be explained that some embodiments of the present application are described as above, and other embodiments are within the scope of the appended claims. In some cases, the action(s) or step(s) as recorded in the claims may be performed in a sequence different from that in the above embodiment(s), and the expected result can still be achieved. In addition, it is not necessary for the process(es) as illustrated in the figure(s) to show a certain sequence or continuous sequence to achieve the expected result. In some implementations, it may be feasible or advantageous to perform multi-task processing or parallel processing.

Based on the same inventive concept, corresponding to the method according to any above embodiment, a device for multi-task learning based on federated learning is further provided in the present application.

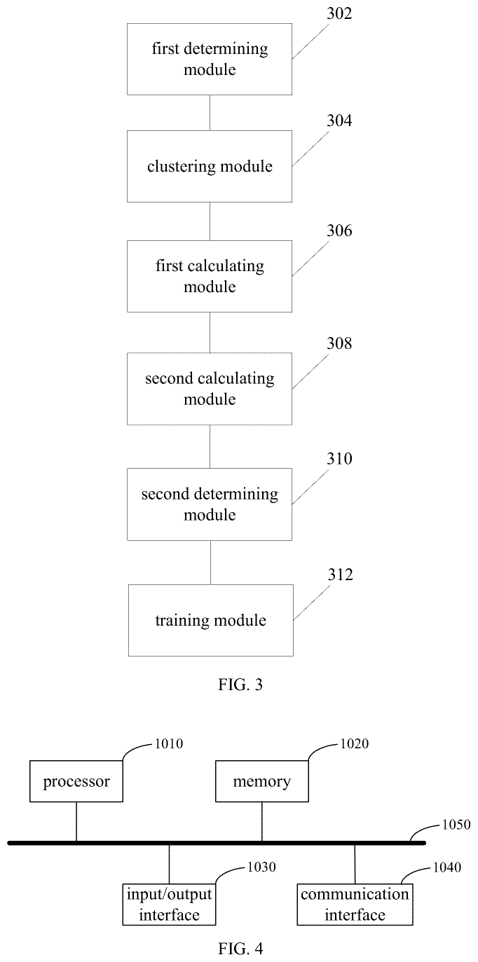

Referring to FIG. 3, the device for multi-task learning based on federated learning comprises:
a first determining module 302, configured for determining participating nodes;
a clustering module 304, configured for performing clustering to the participating nodes and determining several clusters;
a first calculating module 306, configured for determining a cluster model according to the several clusters and by means of calculation with the federated learning;
a second calculating module 308, configured for determining a cluster key feature set of any one of the clusters according to the cluster model and by means of calculation with the SHAP framework;
a second determining module 310, configured for determining a global model according to the cluster key feature set; and
a training module 310, configured for training the global model according to the any one of the clusters, and determining the cluster model of the any one of the clusters, wherein a plurality of the clusters are used for achieving multi-task learning.

In order to facilitate description, when the above device is described, various modules classified in function are described respectively. Certainly, in implementation of the present application, it is possible to integrate the functions of various modules into the same one or multiple software and/or hardware structure(s).

The device in the above embodiment is used to implement the corresponding multi-task learning method based on federated learning according to any embodiment as above, and has the beneficial effect(s) of the corresponding method embodiment, which will not be repeated herein.

Based on the same inventive concept, corresponding to the method according to any above embodiment, an electronic device is further provided in the present application, comprising a memory, a processor, and a computer program which is stored on the memory and can run on the processor, and the multi-task learning method based on federated learning according to any embodiment is implemented when the processor is executing the program.

FIG. 4 shows a diagram of hardware structure of a more specific electronic device as provided in the present embodiment. The device may comprise: a processor 1010, a memory 1020, an input/output interface 1030, a communication interface 1040 and a bus 1050. Herein, the processor 1010, the memory 1020, the input/output interface 1030 and the communication interface 1040 are in communication connection with one another in the device by the bus 1050.

The processor 1010 may be embodied by a general CPU (central processing unit), a micro processor, an ASIC (Application Specific Integrated Circuit), or one or more integrated circuits, for executing related programs to implement the technical solutions as provided in the embodiments of the present description.

The memory 1020 may be embodied by a ROM (Read Only Memory), an RAM (Random Access Memory), a static storage device, a dynamic storage device, or other forms. The memory 1020 may store an operation system or other application programs. When the technical solutions as provided in the embodiments of the present description are implemented by software or firmware, the related program codes are stored in the memory 1020, and are called by the processor 1010 for execution.

The input/output interface 1030 is used to connect with an input/output module, to achieve information input and output. The input/output module may be used as a component configured in the device (not shown in the figure), or may be externally connected with the device to provide the respective function(s). Herein, the input device may comprise a keyboard, a mouse, a touch screen, a microphone, various types of sensors, and the like. The output device may comprise a display, a loudspeaker, a vibrator, an indication lamp, and the like.

The communication interface 1040 is used to connect with a communication module (not shown in the figure), to achieve communication interaction of the present device with other devices. Herein, the communication module may achieve communication via a wired manner (such as USB, netting wires, etc.), or may achieve communication via a wireless manner (such as mobile network, WiFi, Bluetooth, etc.).

The bus 1050 transmits information between various components (such as the processor 1010, the memory 1020, the input/output interface 1030 and the communication interface 1040) of the device.

It should be explained that though only the processor 1010, the memory 1020, the input/output interface 1030, the communication interface 1040 and the bus 1050 are shown in the above device, the device in a specific implementation process may further comprise other components necessary for normal operation. In addition, it is understandable for those skilled in the art that the above device may only comprise the components necessary to implement the solution of the embodiment of the present description, rather than all the components as shown in the figure.

The electronic device in the above embodiment is used to implement the corresponding multi-task learning method based on federated learning according to any embodiment as above, and has the beneficial effect(s) of the corresponding method embodiment, which will not be repeated herein.

Based on the same inventive concept, corresponding to the method according to any above embodiment, a non-transitory computer-readable storage medium storing a computer instruction is further provided in the present application, wherein the computer instruction is used to make a computer execute the multi-task learning method based on federated learning according to any embodiment as above.

The computer-readable storage medium of the present embodiment comprises volatile and non-volatile, mobile and non-mobile media, and can store information by any method or technology. The information may be computer-readable instructions, data structures, program modules or other data. Examples of the storage medium for computers comprise, but are not limited to, a phase change RAM (PRAM), a static random access memory (SRAM), a dynamic random access memory (DRAM), RAMs of other types, a read-only memory (ROM), an electrically erasable programmable read-only memory (EEPROM), a flash memory or memories with other technologies, a compact disc read-only memory (CD-ROM), a digital video disk (DVD) or other optical memories, a cassette tape, a magnetic tape or disk storage or other magnetic storage devices or any other non-transmittable media, and can store information which can be accessed by a computing device.

The storage medium in the above embodiment stores the computer instruction which is used to make the computer execute the multi-task learning method based on federated learning according to any embodiment as above, and has the beneficial effect(s) of the corresponding method embodiment, which will not be repeated herein.

It should be understandable by those skilled in the art that the discussion on any above embodiment is provided only in an exemplary manner, and it is not intended to suggest/imply that the scope of the present application (comprising the claims) is limited to these examples. In the concept of the present application, the technical features in the above embodiments or different embodiments can be combined, the steps thereof can be implemented in any sequence. There are many other variations to the different aspects of the present application as described above, and these variations are not provided in detail for concision.

In addition, in order to simplify the explanation and discussion and to make the embodiments of the present application more understandable, the well known power source/grounding connection of IC chips and other components may or may not be shown in the provided figures. In addition, a device may be shown in a manner of block diagram to make the embodiments of the present application more understandable, and consideration is taken based on the facts that the details in the implementation manner of the device in the block diagram(s) are highly dependant on the context for implementing an embodiment of the present application (that is, these details should completely fall within the scope as understood by those skilled in the art). When specific details (such as circuits) are explained to describe the exemplary embodiment of the present application, it is obvious for those skilled in the art to implement the embodiments of the present application without these specific details or with these specific details changed. Therefore, the description should be considered as illustrative, rather than in a limiting sense.

Though the present application has been described in connection with specific embodiments of the present application, several substitutions, modifications and variations to these embodiments according to the above description will be obvious to those skilled in the art. For example, other memory architectures (such as dynamic RAM (DRAM)) may use the embodiments as discussed.

The embodiments of the present application are intended to cover any of such substitutions, modifications and variations within a broad scope of the appended claims. Therefore, any omission, modification, equivalent substitution, improvement, and the like made within the spirit and principle of embodiments of the present application will fall within the protection scope of the present application.

What is claimed is:

1. A multi-task learning method based on federated learning, comprising:
determining participating nodes;
performing clustering to the participating nodes and determining several clusters;
determining a cluster model according to the several clusters and by means of calculation with the federated learning;
determining a cluster key feature set of any one of the clusters according to the cluster model and by means of calculation with a SHapley Additive exPlanations (SHAP) framework;
determining a global model according to the cluster key feature set; and
training the global model according to the any one of the clusters, and determining the cluster model of the any one of the clusters, wherein a plurality of the clusters are used for achieving multi-task learning.

2. The method according to claim 1, wherein performing clustering to the participating nodes and determining several clusters comprises:
determining a node training model, and training the participating nodes by the node training model;
determining a training time and a model weight in response to determining that a preset number of times of training is reached; and
performing clustering to the participating nodes according to the training time and the model weight, and determining several clusters.

3. The method according to claim 2, further comprising:
performing clustering to the participating nodes by the K-Means algorithm.

4. The method according to claim 1, wherein determining a cluster model according to the several clusters and by means of calculation with the federated learning comprises:
determining an according to the clusters;
training the clusters according to the cluster center and by the federated learning; and
determining the cluster model according to the clusters in response to determining that a number of times of training reaches a preset threshold.

5. The method according to claim 1, wherein determining a cluster key feature set of any one of the clusters according to the cluster model and by means of calculation with the SHAP framework comprises:
analyzing the cluster model by the SHAP framework, and determining a data feature and a data feature value of any one of the participating nodes in the clusters;
determining a node key feature set according to the data feature value; and
obtaining a union set for a plurality of the node key feature sets, and determining the cluster key feature set.

6. The method according to claim 5, wherein determining a node key feature set according to the data feature value comprises:
determining the data feature corresponding to the data feature value as a key feature in response to determining that the data feature value is higher than a preset threshold; and
determining the node key feature set according to the key feature.

7. The method according to claim 1, wherein determining a global model according to the cluster key feature set comprises:
obtaining an intersection set for a plurality of the cluster key feature sets, and determining a global key feature set; and
performing feature masking for data of the participating nodes according to the global key feature set, and determining the global model.

8. A device for multi-task learning based on federated learning, comprising:
a first determining module, configured for determining participating nodes;
a clustering module, configured for performing clustering to the participating nodes and determining several clusters;
a first calculating module, configured for determining a cluster model according to the several clusters and by means of calculation with the federated learning;
a second calculating module, configured for determining a cluster key feature set of any one of the clusters according to the cluster model and by means of calculation with a SHapley Additive exPlanations SHAP framework;
a second determining module, configured for determining a global model according to the cluster key feature set; and
a training module, configured for training the global model according to the any one of the clusters, and determining the cluster model of the any one of the clusters, wherein a plurality of the clusters are used for achieving multi-task learning.

9. An electronic device, comprising a memory, a processor, and a computer program which is stored on the memory and can be executed by the processor, wherein the method according to claim 1 is implemented when the processor is executing the computer program.

10. A non-transitory computer-readable storage medium, storing a computer instruction, wherein the computer instruction is used to make a computer execute the method according to claim 1.
